(19) United States
(12) Patent Application Publication
(10) Pub. No.: US 2009/0274152 A1
(43) Pub. Date: Nov. 5, 2009

(54) Method And System For Disseminating Time-Sensitive Economic Data To Market Participants

(76) Inventors: Matthew Saul Edelstein, Wilmette, IL (US); David Howe, Woodstock, IL (US); John S. Chon, Skokie, IL (US)

Correspondence Address: ST. ONGE STEWARD JOHNSTON & REENS, LLC, 986 BEDFORD STREET, STAMFORD, CT, 06905-5619, US

(21) Appl. No.: 12/434,999

(22) Filed: May 4, 2009

Related U.S. Application Data
(60) Provisional application No. 61/049,995, filed on May 2, 2008.

(51) Int. Cl. H04L 12/56; G06F 17/30

(52) U.S. Cl. 370/390; 707/104.1; 707/10

(57) ABSTRACT

A system and method for disseminating time-sensitive economic information to one or more clients is disclosed. The system includes a computer system and at least one database in communication with the computer system. The database includes a number of XML templates having fields corresponding to one or more economic indicators. The system further includes software executing on the computer system for encoding the XML templates into binary packets, and simultaneously transmitting the binary packets to clients in communication with the computer system via UDP multicast. In some embodiments the system includes software for validating the data entered into the XML templates and for confirming the accuracy of the data included in the binary packet. A method in accordance with the present system is also enclosed.

### CROSS-REFERENCE TO RELATED APPLICATIONS

The present application claims the benefit under 35 U.S.C. §119 (e) of the Provisional Patent Application Ser. No. 61/049,995 filed May 2, 2008, which is herein incorporated by reference.

### FIELD OF THE INVENTION

The present invention relates to the field of financial trading, and in particular relates to a system and method for disseminating time-sensitive economic data to clients over a network.

### BACKGROUND OF THE INVENTION

Economic news is a key driver of the value of financial securities, from bonds to stocks and options. As a result, traders of those securities have long sought to subscribe to news services that would provide them with accurate, reliable news as quickly as possible, so they could gain advantages over other traders who might not yet have that information.

Many government agencies collect and distribute data related to key economic indicators. For example, the Department of Labor, the Department of the Treasury, the Department of Commerce, and other governmental agencies and private groups, distribute economic reports. Each economic report may comprise a plurality of different components. For example, The Department of Commerce regularly issues an economic report on new home sales. The New Home Sales report comprises the following components or data points: New Home Sales, New Homes Sales Revised, New Home Sales m/o/m, New Home Sales mb/rm Revised, New Homes Median Price yloly, New Homes Median Price mlolm, New Homes Inventory, and New Homes Inventory in months at current sales pace.

The results of many economic indicators collected by government agencies and private parties are distributed to recognized news services before they are released to the general public. The predetermined time between when the credentialed reporters or news services receive the data and when they are allowed to send the data to the public is referred to as an embargo. Depending on the situation, the embargo may consist of an honor system where the reporter or news agency will simply refrain from submitting data to the public during the embargo. In other environments, the governmental agency that provided the data maintains an electronic switch that blocks each news service's network access until a specified time.

The market for such financial news services entered a new phase in the decade of the 2000s, as a growing number of traders used computerized “algorithmic” trading strategies to instantly read and react to major news events that would be expected to impact financial securities' value. A typical algorithmic trader researches the history of how the prices of individual securities have responded to unexpected “surprises” when economic news is released. The trader then identifies a series of trades that would be profitable if two conditions are met: A “surprising” economic news release is issued, and markets react as they have in the past. By focusing on the most liquid securities, traders believe they can mitigate the second risk.

However, these trading strategies can be rendered useless if the traders are not among the “first movers” in the identified markets. Historical prices are easily researched and a large number of traders can make similar predictions, creating significant competition among traders. This competition focuses on two methods of differentiation: faster access to economic news, and software that interprets the news and executes the indicated trades more quickly.

The early stages of the market development were driven by the end-user traders, who wrote software programs designed to isolate data points from “natural language headlines” and feed that data into trading systems that could react faster than human “click traders” who were reading first and then reacting to the news.

A disadvantage of such software programs is that although they may react faster than human “click traders” who are first reading the natural language headlines and then reacting to the news, they are still relatively slow.

Another disadvantage of such systems is that they pose a significant risk to traders who use them because they automatically make trades based on isolated data automatically extracted from natural language headlines. If the automated software extraction program misinterprets a natural language headline or extracts the wrong data it could place a significant value at risk in the market.

A second stage of development in the extraction and dissemination of the economic news for trading was driven by incumbent news services. The news services traditionally provided the economic data points to end users in natural language headlines. Such news services began to extract data points from their own natural language feeds, and provide them to algorithmic traders separately. While this development reduced risk of error in data point extraction by the end user, it still had considerable disadvantages.

A disadvantage of this type of news service data extraction is that, although faster and more reliable than end user extraction, it is still relatively slow. News services have continued to follow the news service convention of delivering the news through sequential headlines about each component of an economic data release. For example, the first data on the monthly “Employment Situation” report from the Bureau of Labor Statistics would be the change in payrolls in a first data packet, followed by the national unemployment rate in a separate subsequent data packet. This type of sequential reporting creates a delay in the dissemination of the time-sensitive economic news.

Another disadvantage of this type of sequential system is that such news services use a TCP/IP system to distribute the data. Such a TCP/IP system sends the data to multiple subscribers sequentially. Creating an opportunity for certain subscribers who receive the data earlier in the sequence to gain a trading advantage, and creating a disadvantage to other subscribers who receive the data later in the sequence.

Another disadvantage of such TCP/IP systems is that TCP/IP is a connection oriented protocol, which means that it requires handshaking to set up end-to-end communications. This wastes time and delays delivery of the time-sensitive economic data. In addition TCP requires three packets to set up a socket connection, before any user data can be sent.

Another disadvantage of known systems is that they utilize third party or public networks, such as the World Wide Web, resulting in increased delay.

There is a desire for a system and method for evaluating financial investments that overcomes the limitations of the prior art.

### SUMMARY OF THE INVENTION

It is accordingly an object of the present invention to provide a system and method that that overcomes the limitations of the prior art.

It is a further object of the present invention to decrease the time it takes to distribute economic data from a news service to an end user after an embargo is lifted.

It is yet a further object of the present invention to increase the accuracy of economic data that is distributed by a news service to an end user.

It is yet a further object of the present invention to provide a method and system for disseminating time sensitive economic data to market participants over a network via multicast addressing.

It is a further object of the present invention to provide a method and system for disseminating time sensitive economic data to market participants over a network via user datagram protocol (UDP) multicast addressing. The UDP multicast does not have the associated overhead of TCP/IP.

It is yet a further object of the present invention to provide a method and system that disseminates multiple economic data points to end users over a network in a single packet.

It is yet a further object of the present invention to provide a method and system that disseminates economic data to an end user via a point to point dedicated network. This type of network has considerably less overhead than is often associated with third party of public networks, and is able to distribute multiple components of an economic data release simultaneously, rather than sequentially

It is yet another object of the present invention to provide a method and system for disseminating economic data to and user, wherein the economic data is processed before the embargo is lifted.

It is yet another object of the present invention to provide a method and system for disseminating economic data to an end user, wherein a reporter enters data into an XML template before the embargo is lifted and software executing on the system checks the entered data to make sure it conforms to pre-set standards for the number of digits, placement of decimal points, and overall value, in an effort to improve the integrity of the data supplied to the end user.

It is yet another object of the present invention to provide a method and system for disseminating economic data to an end user, wherein a plurality of reporters enter data from the same economic report on separate templates prior to the end of the embargo. Each template is subsequently encoded into a binary packet, and software executing on the system compares the binary packets for uniformity before the embargo is lifted. If there is a discrepancy between the two or more packets each reporter will be notified of the discrepancy and the data will be re-entered and the process repeated.

It is yet another object of the present invention to provide a method and system for disseminating economic data to an end user, wherein the system transmits the data to the end user upon a down click of a key on a key board or upon the down click of a key on a computer mouse.

These and other objects of the present invention are achieved by providing a system for disseminating time-sensitive economic information to one or more clients including a computer system, at least one database in communication with the computer system comprising a plurality of templates, each of the templates comprising one or more fields corresponding to one or more economic indicators. The system further comprising software executing on the computer system for encoding at least one of the plurality of templates into a first binary packet, software executing on the computer system for transmitting the first binary packet to one or more clients in communication with the computer system via UDP multicast, wherein the first binary packet comprises data corresponding to at least one of the economic indicators.

In some embodiments, the system encodes the at least one template into the first binary packet prior to a lifting of an embargo on a dissemination of data related to the one or more economic indicators. In further embodiments the first binary packet comprises data corresponding to a plurality of the economic indicators. It yet further embodiments of the present invention the first binary packet comprises data corresponding to one or more data points of one or more economic reports authored by one or more of the Department of Labor, the Department of Commerce, and the Department of The Treasury.

In some embodiments the present invention includes software executing on the computer system for monitoring an electronic switch maintained by a provider of the one or more economic reports. For example a switch maintained by one or more of the Department of Labor, the Department of Commerce, and the Department of The Treasury. The system further includes software executing on the computer system for transmitting the first binary packet to one or more clients in response to a detection of a change in position of the electronic switch. In yet other embodiments, a keyboard is in communication with the computer system comprising one or more keys. Software executing on the computer system transmits the first binary packet to one or more clients in response to a down click of one of the keys of the keyboard. In yet other embodiments of the present invention a computer mouse is in communication with the computer system comprising one or more mouse keys. Software executing on the computer system transmits the first binary packet to one or more clients in response to a down click of one of the keys of the computer mouse.

In some embodiments of the present invention a first interface, for example a keyboard, computer workstation, mobile computing device, or the like, is connected to the computer system. Software executing on the computer system receives data related to one or more economic indicators entered at the first interface and inserts the data into one or more fields of a first template among the plurality of templates. In yet further embodiments the computer system includes software for validating the data inserted into the one or more fields of the first template. In yet further embodiments the software validates the data for format based on a predetermined standards and compliance based on predetermined values. Through this validation software module the present invention provides a first check of the accuracy of the data entered into the system.

In some embodiments of the present invention a second interface is further connected to the computer system. Software executing on the computer system receives data related to one or more economic indicators entered at the second interface and inserts the data into one or more fields of a second template among the plurality of templates. Software executing on the system compares the first binary packet with a second binary packet encoded from the second template. In yet further embodiments the software compares the first binary packet with the second binary packet using a binary checksum. In yet further embodiments software executing on the computer system transmits a notification to one or more of the first interface and the second interface in response to a discrepancy between the first binary packet and the second binary packet. Through this comparison the present invention provides a second check of the accuracy of the data entered into the system.

In yet further embodiments of the present invention the system transmits the first binary packet to one or more clients in communication with the system via a dedicated or private network. In other embodiments of the present invention transmits the first binary packet to one or more clients in communication with the system via a public network, for example the World Wide Web.

Further provided is a method of disseminating time sensitive economic data to a plurality of clients including the steps of inputting a plurality of data point related to one or more economic indicators into a first XML template, encoding the first XML template into a binary packet, and transmitting the first binary packet to one or more clients in communication with the computer system via a UDP multicast. In some embodiments of the present method the first binary packet is encoded prior to a lifting of an embargo on dissemination of data points related to one or more of the economic indicators contained in the first binary packet. In some embodiments a plurality of data points are inputted into the first XML template.

In yet further embodiments, the method further includes the steps of monitoring an electronic switch maintained by a provider or author of one or more economic indicators or reports thereon, and detecting a change in a position of the electronic switch, wherein the transmitting step is performed in response to a change in the position of the switch. In yet other embodiments the method further includes the steps of down clicking one or more of a key of a key board and a key of a computer mouse, where the transmitting step is performed in response to the down click.

In yet further embodiments of the present invention, the method includes the steps of validating the plurality of data points related to the one or more economic indicators inserted into the first XML template prior to encoding the first XML template. In some embodiments the validating step includes validating the data for one or more of format and compliance with a set of predetermined values.

In some embodiments of the present invention the method further includes the steps of inputting the plurality of data points into a second XML template, encoding the second XML template into a second binary packet, and comparing the first binary packet with the second binary packet. In further embodiments the comparison steps includes comparing the first binary packet with the second binary packet using a binary checksum. Further embodiments of the method include the step of transmitting a notification in response to a discrepancy between said first binary packet and the second binary packet.

These and other objects and advantages of the present invention will become more apparent from the following detailed description considered with reference to the accompanying drawings.

### BRIEF DESCRIPTION OF THE DRAWINGS

FIG. 1 illustrates a system for disseminating time-sensitive economic data to market participants according to one embodiment of the present invention.

FIGS. 2A and 2B illustrate a method for disseminating time-sensitive economic data to market participants according to one embodiment of the present invention.

FIG. 3 illustrates a method for manually releasing time-sensitive economic data after an embargo is lifted according to one embodiment of the present invention.

FIG. 4 illustrates a method for automatically releasing time-sensitive economic data after receipt of an electronic notification that an embargo has been lifted according to one embodiment of the present invention.

FIG. 5 illustrates a system for disseminating time-sensitive economic data to market participants according to one embodiment of the present invention.

FIG. 6A illustrates a portion of a data packet for transferring time-sensitive data according to one embodiment of the present invention.

FIG. 6B illustrates a portion of a data packet for transferring time-sensitive data according to one embodiment of the present invention.

FIG. 7 illustrates an XML template according to one embodiment of the present invention.

FIG. 8 illustrates a format of binary data in accordance with one embodiment of the present invention.

### DETAILED DESCRIPTION OF THE INVENTION

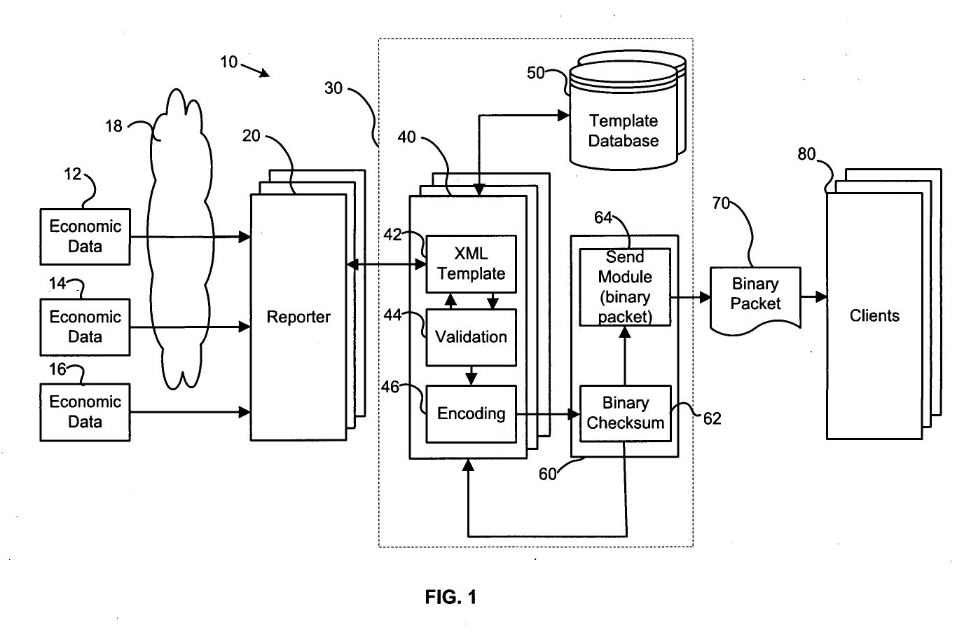

FIG. 1 illustrates a system 10 for disseminating time-sensitive economic data 12, 14, 16 to market participants according to one embodiment of the present invention. The system 10 includes a computer system 30 and at least one database 50 in communication with the computer system 30. The database 50 comprises a plurality of templates 42, each template 42 comprising one or more fields corresponding to one or more economic indicators. The system 10 further includes software 46 executing on the computer system 30 for encoding at least one of the plurality of templates 42 into a first binary packet 70, and software 64 executing on the system 30 for transmitting the first binary packet 70 to one or more clients 80 in communication with the computer system 30 via UDP multicast. The binary packet 70 comprises data corresponding to at least one of the economic indicators.

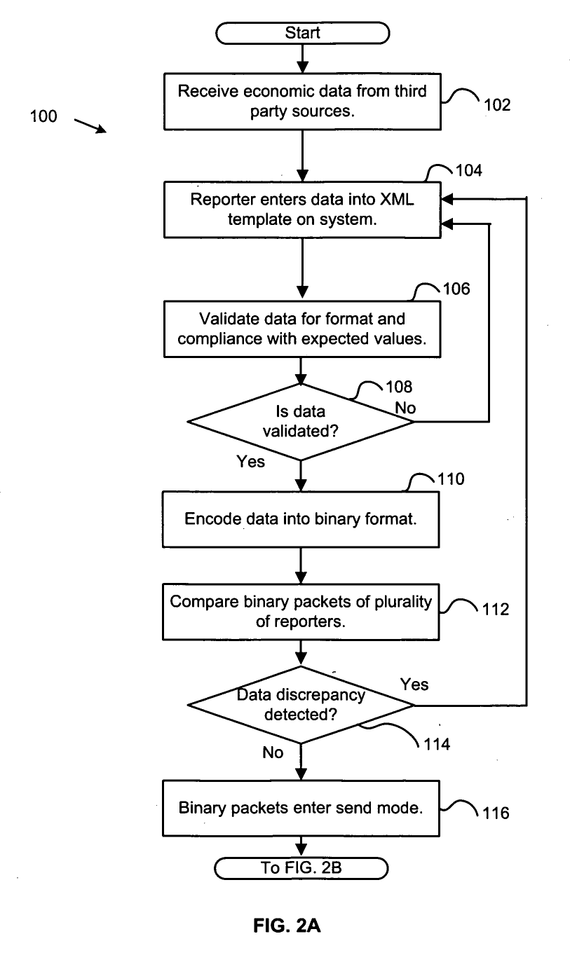

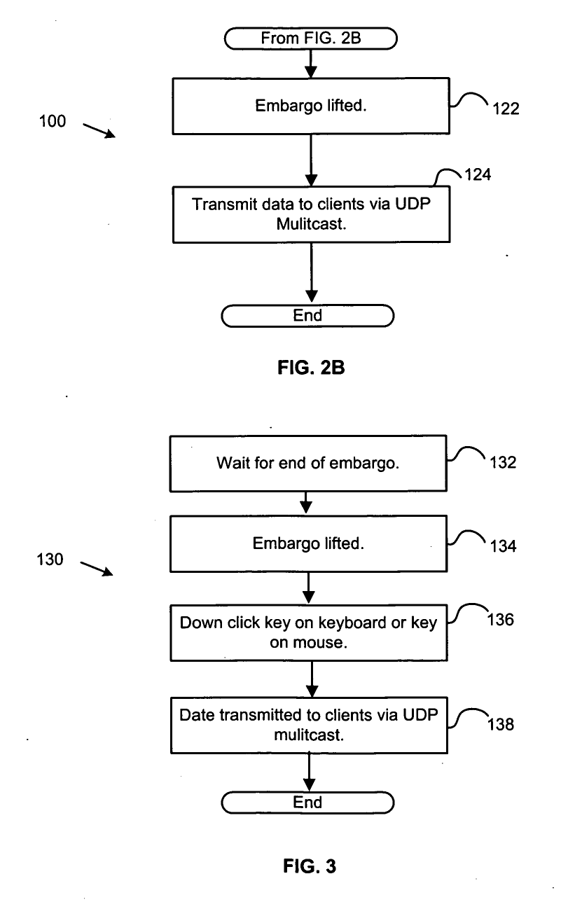

FIG. 2 illustrates a method of disseminating time-sensitive economic data to a plurality of clients 100 in accordance with one embodiment of the present invention. The method 100 includes the steps of receiving economic data from one or more third party sources 102. A reporter then enters the data into an XML template 104. After the data is entered, the data is validated for format and compliance with a set of pre-determined values 106. If the data does not conform, the reporter is notified and prompted to resubmit the data 108. If the data does conform 108 it is encoded into a binary format 110, in some embodiments a binary packet. The binary packet is then compared with one or more additional binary packets to detect any discrepancy between the binary packets 112. If a discrepancy is detected the reporter is notified of the discrepancy and prompted to resubmit the data into the XML template 114. If a discrepancy is not detected, the data is transmitted 124 to one or more clients via UDP multicast after any embargo on dissemination of the data is lifted 122.

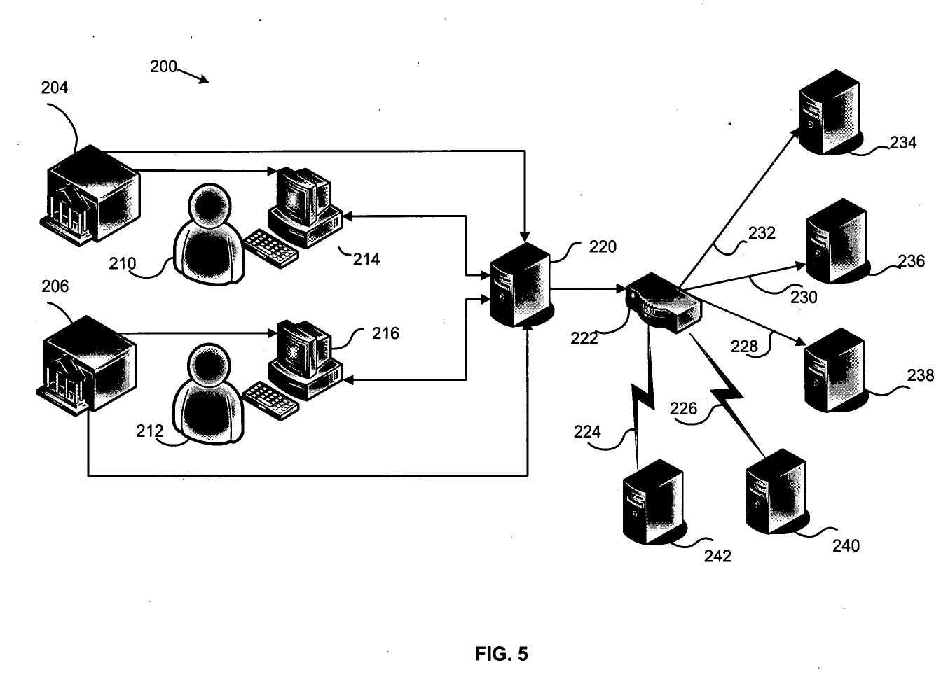

In one embodiment in accordance with the present invention the computer system 30 is a personal computer in communication with one or more clients 80 via a private or public network. In such an embodiment the software routines execute on the personal computer. In other embodiments the computer system 30 may be a plurality of personal computers in communication via a private network or public network such as the World Wide Web. For example, in reference to FIG. 5 the computer system 30 comprises a first reporter computer 214, a second reporter computer 216, and a central computer 220, wherein the computers 214, 216, 220 are in communication via a public or private network. In yet other embodiments of the present invention the computer system 30 comprises a network server in communication with one or more user interfaces, wherein one or more reporters 210, 212 input economic data into XML templates via the user interface. The following examples of the computer system 30 are provided by way of example only, and they are not intended to limit the present invention.

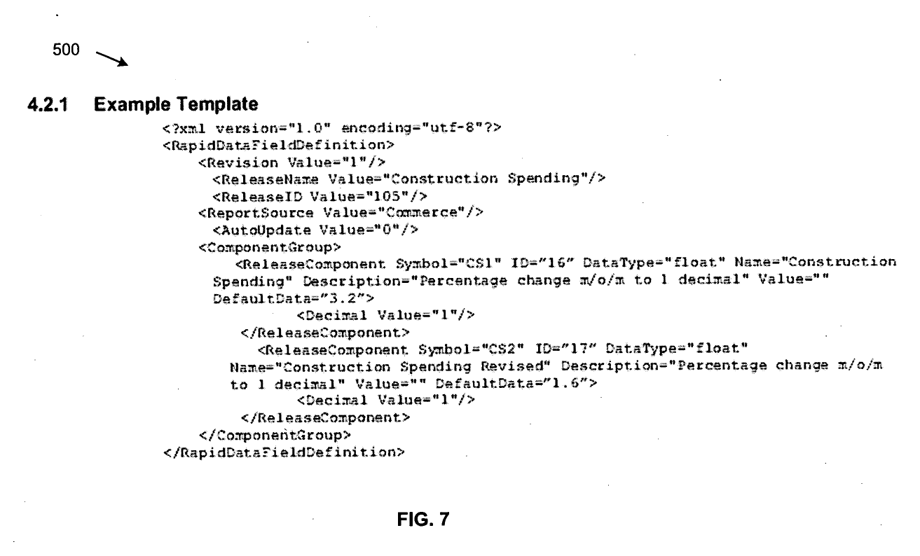

In further reference to FIG. 1, the system 10 further includes at least one database 50 in communication with the computer system 30. The template database 50 includes a plurality of XML templates 42. FIG. 7 illustrates an XML template 500 in accordance with one embodiment of the present invention. Each XML template 500 includes one or more fields corresponding to data related to one or more economic indicators. For example, the XML template 500 includes one or more fields corresponding to data related to one or more data points of an economic report. The Bureau of Labor Statistics authors a monthly economic report titled “Employment Situation.” The report includes several economic indicators, otherwise referred to as data. Some of these data points may be referred to as headline numbers, such as the overall change in payroll jobs nationwide in the previous month and the national unemployment rate. Other of these data points may be referred to subcomponents that focus on employment in specific sectors of the economy.

In further reference to FIG. 1 the system 10 includes a plurality of reporter computers 40 for inputting economic data into the system 10. In other embodiments the reporter 20 inputs economic data through one or more user interfaces 40 in communication with the computer system 30. Software executing on the computer system 10 receives data 12, 14, 16 entered at the reporter computer 20. Typically the reporter 20 receives economic data 12,14,16 from one or more sources of such data, for example Federal government agencies and private parties who periodically author economic reports. The economic data 12,14 may be transmitted to the reporter 20 via a communication link through the Internet 18. The economic data 16 may also be transmitted to the reporter 20 via regular mail or any other known means. In some embodiments, for example in reference to FIG. 5, the economic data is transmitted directly to the reporter computer 214, 216 from the author of such data 204, 206. Finally, in some embodiments on the present invention software executing on the computer system automatically extracts data points from economic reports and automatically inputs it into the XML templates without the aid of a reporter 20, or with limited control by the reporter 20.

The economic data 12, 14, 16 is usually distributed to the reporters 20 before the data 12, 14, 16 is released to the public. Typically the author of the data 12, 14, 16 establishes a pre-determined time during which the reporter 20 is prohibited from releasing the data 12, 14, 16 to the public. This period of time may be referred to as an embargo. During the embargo the economic data is formatted by the system 10 for use by the clients 80 so that when the embargo is lifted 122 the data is simultaneously transmittable to one or more clients 80 in communication with the computer system 30 via a dedicated private network. In some embodiments one or more of the clients 80 may by in communication with the computer system 30 via a public network.

After a reporter 20 receives economic data 12, 14, 16 the reporter inputs the economic data 12, 14, 16 into the computer system 30. The reporter 20 selects an XML template 42 from the template database 50 that corresponds to the economic data 12, 14, 16 being inputted by the reporter 42. In reference to FIG. 1, the reporter computer 40 displays an XML template 50 that corresponds to the economic data 12, 14, 16. In some embodiments software executing on the computer system 30 retrieves the specified template 42 from the template database 50. The reporter 20 enters the economic data 12, 14, 16 into one or more fields a specified on the XML template 42. In reference to FIG. 5, a system 200 in accordance with the present invention is shown. The reporter computers 214, 216 receive economic data from one or more authors of the economic data 204, 206. The reporter 210, 212 enters the data into the reporter computer 214, 216.

In reference to FIG. 1, after the computer system 30 receives the economic data 12, 14, 16 in an XML template 42, software 44 executing on the computer system 30 executes a data validation routine. The software module 44 automatically validates the data 12, 14, 16 entered into the template 42 to make sure it conforms to pre-set standards for the number of digits, placement of decimal points, and overall value. In some embodiments, if the validation software module 44 detects a discrepancy between the data entered by the reporter 20 and the pre-set standards, the software module 44 transmits a notification of the discrepancy to the reporter computer 40. In such a case the reporter 20 can correct the discrepancy.

Further referring to FIG. 1, after the validation module 44 validates the data entered into the XML template, the reporter locks the XML template 42. In some embodiments the reporter 20 locks the XML template 42 with a key stroke on the reporter computer 40. In yet other embodiments the validation software module 44 automatically locks the XML template when it determines there is no discrepancy between the entered economic data and the pre-set standards. In yet other embodiments the reporter 20 may lock the XML template 42 even though the validation software module 44 detected a discrepancy in the data.

After the XML template 42 is locked an encoding software module 46 comprising software executing on the computer system 30 prepares the data for delivery to one or more clients 80 in communication with the computer system 80. In the embodiment shown in FIG. 1, the encoding module 46 encodes the XML template 42 into a binary packet 70. In further reference to FIG. 1, the encoding module 46 encodes the XML template and the economic data contained therein into a binary packet 70 called a queue (hereinafter interchangeably referred to as “binary packet,” “queue,” and “queued binary packet”).

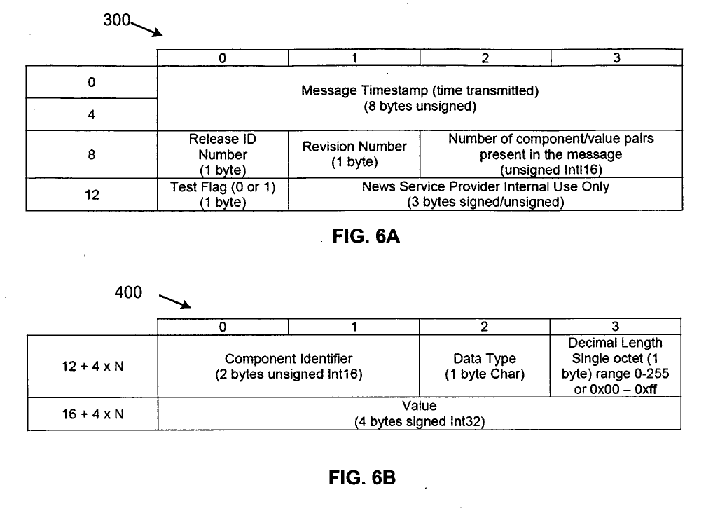

In reference to FIG. 6-8, the format of binary data 600 in accordance with one embodiment of the present invention is shown. The binary packet includes at least one header 300 that identifies the relevancy of the data contained in the binary packet 600. The binary packet 600 further includes one or more components 400 that include the economic data. In reference to FIG. 6A a header 300 of a binary packet in accordance with one embodiment of the present invention is shown. In reference to FIG. 6B a component 400 of a binary packet in accordance with one embodiment of the present invention is shown. In some embodiments the binary packet may contain a plurality of headers 300 corresponding to a plurality of releases of economic data. The binary packet may further include one or more components 400 corresponding to each header 300.

In some embodiments of the present invention, as discussed above, the encoding software module 46 executes on the computer system 30. In the embodiment shown in FIG. 1, the encoding software module 46 executes on the reporter computer 40. In yet other embodiments of the present invention the encoding software module 46 executes on a central computer 60 in communication with one or more reporter computers 20. In other embodiments of the present invention the computer system 30 comprises a network server with the encoding software module 46 residing thereon. It should be understand the system 10 may comprise any number of different configurations of hardware and software, and that the configurations described in the application are for purposes of illustrating certain embodiments of the present invention, and are not intended to limit the present invention.

In some embodiments of the present invention the encoded data is stored on the computer system 30 until an embargo on dissemination of the economic data is lifted. In reference to FIG. 1, the computer system 30 comprises software 64 executing on the computer system 30. The software 64 transmits the binary packet 70 on one or more clients 80 in communication with the computer system 30.

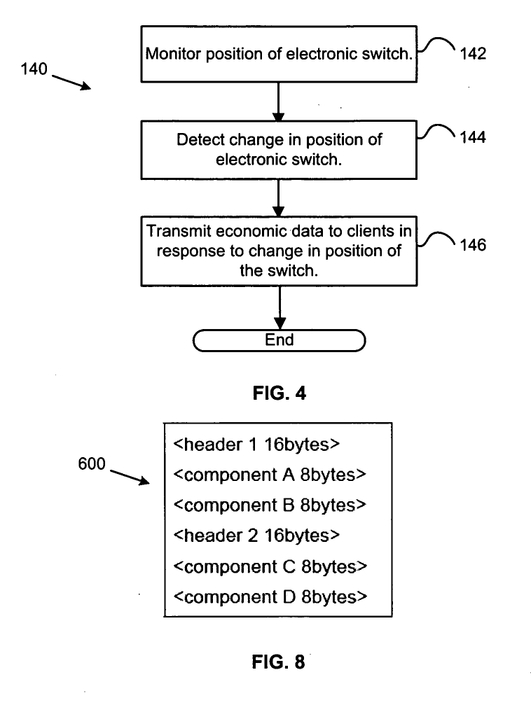

In some embodiments, software executing on the computer system 30 monitors an electronic switch maintained by a provider of the economic data. Typically, the author of the data will change the position of the switch at a time when dissemination of the data to the public is permitted. The computer 30 system further includes software that transmits the data to the one or more clients in response to a detection of a change in position of the electronic switch. A method 130 in accordance with the present invention in shown in FIG. 4. The method includes the steps of monitoring the position of the electronic switch 142, detecting a change in the position of the electronic switch 144, and transmitting economic data to one or more clients in response to a change in position of the electronic switch 146.

In some embodiments the reporter 20 initiates transmittal of the data. In reference to FIG. 3 an embodiment of the present invention is shown in which the reporter 20 waits for the embargo to be lifted 132. After the embargo is lifted, the reporter 20 down clicks a key on a keyboard or a key on a computer mouse 136. The data is transmitted to the clients 80 in response to the down click of the key 138. In this embodiments the reporter 20 down clicks a key of a keyboard or key of a computer mouse in communication with the computer system 30.

In reference to the embodiment shown in FIG. 1, the computer system 30 further comprises software 62 executing on the computer system 30 for comparing one or more binary packets encoded from the one or more XML templates. The software 62, also referred to as the binary checksum module, automatically compares a first binary packet with a second binary packet in order to detect any discrepancy in the data contained therein. In this embodiment the central computer 30 receives economic data from a plurality of reporters 20, wherein the computer system 30 inputs data from each reporter 20 in a separate XML template 42. For example, the encoding software module 46 encodes first and second XML templates 42 prepared by first and second reporters resulting in first and second binary packets. In some embodiments a first binary packet will correspond to first data entered by a first reporter on a first template. A second binary packet will correspond to second data entered by a second reporter on a second template.

In reference to FIG. 1, the checksum module 62 compares the first binary packet with the second binary packet to detect any discrepancy in the data. In some embodiments, as shown in FIG. 1, the software module 62 is a binary checksum module which compares the first and second binary packets. In the embodiment shown in FIG. 1, if the binary checksum module detects a discrepancy between the first and second binary packets, software executing on said computer system 30 transmits a notification to first and second reporter computer 40 notifying said reporters 20 of the discrepancy. In which case the reporters 20 will re-enter the data and the routine will repeat itself. It the software 62 executing on the computer system 30 does not detect a discrepancy the binary packets enters a send mode where it awaits transmittal to one or more clients 80 when the embargo is lifted. In this way, the system is able improve the accuracy of economic information transmitted to the client.

In further reference to FIG. 1, after the data is encoded and validated it is transmitted to the client 80. In some embodiments of the present invention, software executing on the computer system 30 transmits the binary packet to one or more clients 80 in communication with the computer system via a UDP multi cast. In reference to FIG. 1 the computer system 30 transmits one or more binary packets 70 to clients 80 in communication with the system 30 via a private network. The data is transmitted from the central computer 60 to a router in a remote location via a point-to-point connection. The router then simultaneously transmits the data to a plurality of clients 80 in communication with the router.

It should be understood that the computer system may transmit the data to clients 80 via a private network, or a public network, such as the World Wide Web, or any combination thereof or other known network. In reference to FIG. 5, one embodiment of the present invention is shown in which a central computer 220 transmits the data to a router 222 via a point-to-point connection. The router simultaneously transmits the data to client computers 234, 236, 238 via a private dedicated network 228, 230, 232. The router simultaneously transmits the data to client computers 240, 242 via a public network 224, 226. It is preferred that the data is sent to the clients 80 via a UDP multicast; however any protocol may be used to transfer the data to the clients 80. The UDP multicast enables the system to send multiple data points related on one or more economic indicators to multiple clients both immediately and simultaneously.

It should be understood that the foregoing is illustrative and not limiting, and that obvious modifications may be made by those skilled in the art without departing from the spirit of the invention. Accordingly, reference should be made primarily to the accompanying claims, rather than the foregoing specification, to determine the scope of the invention.

What is claimed is:

1. A system for disseminating time-sensitive economic information to one or more clients, comprising:
a computer system;
at least one database in communication with said computer system comprising a plurality of templates, each template comprising one or more fields corresponding to one or more economic indicators;
software executing on said computer system for encoding at least one of said plurality of templates into a first binary packet;
software executing on said computer system for transmitting said first binary packet to one or more clients in communication with said computer system via UDP multicast;
wherein said first binary packet comprises data corresponding to at least one of said economic indicators.

2. The system of claim 1, wherein said at least one template is encoded into said first binary packet prior to a lifting of an embargo on a dissemination of data related to said one or more economic indicators contained in said first binary packet.

3. The system of claim 2, wherein said first binary packet comprises data corresponding to a plurality of said economic indicators.

4. The system of claim 1, wherein said first binary packet comprises data corresponding to a plurality of data points related to one or more economic indicators.

5. The system of claim 2, further comprising:
software executing on said computer system for monitoring an electronic switch maintained by a provider of said one or more economic indicators;
software executing on said computer system for transmitting said first binary packet to said one or more clients in response to a detection of a change of a position of said electronic switch.

6. The system of claim 2, further comprising:
a keyboard in communication with said computer system comprising one or more keys;
software executing on said computer system for transmitting said first binary packet to said one or more clients in response to a down click of said one or more keys.

7. The system of claim 2, further comprising:
a mouse in communication with said computer system comprising one or more mouse keys;
software executing on said computer system for transmitting said first binary packet to said one or more clients in response to a down click of said one or more mouse keys.

8. The system of claim 1, further comprising:
a first interface in communication with said computer system;
software executing on said computer system for receiving said data related to one or more economic indicators entered at said first interface and for inserting said data into one or more fields of a first template;
wherein said first template is one of said plurality of templates.

9. The system of claim 8, further comprising:
software executing on said computer system for validating said data inserted into one or more fields of said first template.

10. The system of claim 9, wherein said software validates said data for one or more of format and compliance with a set of predetermined values.

11. The system of claim 8, further comprising:
a second interface in communication with said computer system;
software executing on said computer system for receiving data related to said one or more economic indicators entered at said second interface and inserting said data into one or more fields of a second template, wherein said second template is one of said plurality of templates;
software executing on said computer system for comparing said first binary packet encoded from said first template with a second binary packet encoded from said second template.

12. The system of claim 11, wherein said software compares said first binary packet with said second binary packet using a binary checksum.

13. The system of claim 12, further comprising:
software executing on said computer system for transmitting a notification to one or more of said first interface and said second interface in response to a discrepancy between said first binary packet and said second binary packet.

14. The system of claim 1, wherein said system transmits said first binary packet to one or more clients through a dedicated network.

15. A method of disseminating time-sensitive economic data to a plurality of clients comprising the steps:
inputting a plurality of data points related to one or more economic indicators into a first XML template;
encoding said first XML template into a first binary packet;
transmitting said first binary packet to one or more clients in communication with said computer system via UDP multicast.

16. The method of claim 15, wherein said first binary packet is encoded prior to a lifting of an embargo on dissemination of data points related to one or more economic indicators contained in said first binary packet.

17. The method of claim 16, wherein a plurality of data points related to a plurality of economic indicators is inputted into said first XML template.

18. The method of claim 16, further comprising the steps of:
monitoring an electronic switch maintained by a provider of said one or more economic indicators;
detecting a change in a position of said electronic switch;
wherein said transmitting step is performed in response to a change in said position of said electronic switch.

19. The method of claim 16, further comprising the steps of:
down clicking one or more of a key of a keyboard and a key of a computer mouse;
wherein said transmitting step is performed in response to said down click.

20. The method of claim 15, further comprising the steps of:
validating said plurality of data points related to said one or more economic indicators inserted into said first XML template prior to encoding said first XML template.

21. The method of claim 20 wherein said validating step comprises validating said data for one or more of format and compliance with a set of predetermined values.

22. The method of claim 15, further comprising the steps of:
inputting said plurality of data points into a second XML template;
encoding said second XML template into a second binary packet;
comparing said first binary packet with said second binary.

23. The method of claim 22 wherein said comparing step comprises comparing said first binary packet with said second binary packet using a binary checksum.

24. The method of claim 23, further comprising the steps of:
transmitting a notification in response to a discrepancy between said first binary packet and said second binary packet.

25. The method of claim 15 wherein said transmitting step comprises transmitting said first binary packet to one or more clients over a dedicated private network.

26. A news service comprising:
a computer system;
a database in communication with said computer system comprising a plurality of XML templates, said plurality of XML templates each comprising one or more fields corresponding to one or more components of an economic report issued by one or more of the Department of Labor, the Department of Commerce, and the Department of The Treasury;
an interface in communication with said computer system for entering said one or more components of said economic report into a first XML template of said plurality of XML templates;
software executing on said computer system for validating said data entered into said first XML template;
software executing on said computer system for formatting said first XML template into a binary packet;
a dedicated network in communication with said computer system, and further in communication with a plurality of clients in a location remote from said computer system;
software on executing on said computer system for simultaneously transmitting said binary packet to said plurality of clients via said dedicated network.
